(19) United States
(12) Patent Application Publication
(10) Pub. No.: US 2007/0069988 A1
(43) Pub. Date: Mar. 29, 2007

(54) PLASMA DISPLAY APPARATUS AND DRIVING METHOD THEREOF

(76) Inventors: Kirack PARK, Chilgok-gun (KR); Jongwoon Bae, Gumi-si (KR); Seonghwan Ryu, Gumi-si (KR); Yoonjoo Cho, Seoul (KR); Dooyong Hwang, Yongin-si (KR)

Correspondence Address: FLESHNER & KIM, LLP, P.O. BOX 221200, CHANTILLY, VA, 20153, US

(21) Appl. No.: 11/535,206

(22) Filed: Sep. 26, 2006

(30) Foreign Application Priority Data
Sep. 26, 2005 (KR) 10-2005-0089567

(51) Int. Cl. G09G 3/28

(52) U.S. Cl. 345/67

(57) ABSTRACT

A plasma display apparatus is disclosed, which can prevent the generation of a displacement current having an excessive magnitude, and therefore prevent an electrical damage to a driver, by applying scan signals to scan electrodes using at least one of a plurality of scan types which are different from each other in the application order of scan signals. The plasma display apparatus comprises: a plurality of scan electrodes; a plurality of sustain electrodes formed parallel to the scan electrodes; data electrodes intersecting the scan electrodes and the sustain electrodes; a scan driver for applying scan signals to the plurality of scan electrodes using a first scan type in a first subfield of an image frame and applying scan signals to the plurality of scan electrodes using a second scan type, which is different from the first scan type in the order of applying scan signals, in a second subfield thereof; a data driver for applying data signals to the data electrodes in phase with the scan signals during an address period and applying data signals to at least one of a plurality of data electrode groups comprising at least one data electrode at a time point different from an application time point of a scan signal applied to the scan electrodes; and a sustain driver for applying to the sustain electrodes a first sustain bias signal, whose voltage is lower than that of a second sustain bias signal applied to the sustain electrodes during an address period, during a period starting from a set-down period of a reset period, which is earlier than the address period, before a scan signal is applied to the scan electrodes.

This Nonprovisional application claims priority under 35 U.S.C. § 119(a) on Patent Application No. 10-2005-0089567 filed in Korea on Sep. 26, 2005 the entire contents of which are hereby incorporated by reference.

### BACKGROUND

1. Field of the Invention

This document relates to a plasma display apparatus and a driving method thereof.

2. Background of the Related Art

A plasma display apparatus comprises a plasma display panel having electrodes and a driver for applying a driving signal to the electrodes of the plasma display panel.

Typically, in the plasma display panel, a phosphor layer is formed in discharge cells defined by barrier ribs, and a plurality of electrodes is formed. The driver applies a driving signal to the discharge cells via the electrodes.

Then, a discharge occurs in the discharge cells by an applied driving signal. When a discharge occurs in the discharge cells by a driving signal, a discharge gas filled in the discharge cells generates vacuum ultraviolet rays, and these vacuum ultraviolet rays excite the phosphor formed in the discharge cells to emit visible light. By this visible light, images are displayed on the screen of the plasma display panel.

### SUMMARY

A plasma display apparatus according to one embodiment of this document comprises: a plurality of scan electrodes; a plurality of sustain electrodes formed parallel to the scan electrodes; data electrodes intersecting the scan electrodes and the sustain electrodes; a scan driver for applying scan signals to the plurality of scan electrodes using a first scan type in a first subfield of an image frame and applying scan signals to the plurality of scan electrodes using a second scan type, which is different from the first scan type in the order of applying scan signals, in a second subfield thereof; a data driver for applying data signals to the data electrodes in phase with the scan signals during an address period and applying data signals to at least one of a plurality of data electrode groups comprising at least one data electrode at a time point different from an application time point of a scan signal applied to the scan electrodes; and a sustain driver for applying to the sustain electrodes a first sustain bias signal, whose voltage is lower than that of a second sustain bias signal applied to the sustain electrodes during an address period, during a period starting from a set-down period of a reset period, which is earlier than the address period, before a scan signal is applied to the scan electrodes.

### BRIEF DESCRIPTION OF THE DRAWINGS

The embodiment of this document will be described in detail with reference to the following drawings in which like numerals refer to like elements.

FIG. 1 is a view for explaining one example of the configuration of a plasma display apparatus according to one embodiment of this document;

FIG. 2 is a view for explaining one example of the structure of a plasma display panel that may belong to a plasma display apparatus according to one embodiment of this document;

FIG. 3 is a view for explaining one example of a method for implementing gray levels of an image in a plasma display apparatus according to one embodiment of this document;

FIGS. 4a to 4c are views for explaining one example of the operation of a plasma display apparatus according to one embodiment of this document;

FIG. 5 is a view for explaining one example of another method for applying a sustain bias signal;

FIGS. 6a to 6d are views for explaining one example of a method for differentiating an application time point of a scan signal from an application time point of a data signal in a plasma display apparatus according to one embodiment of this document;

FIGS. 7a and 7b are views for explaining the reason for differentiating an application time point of a scan signal from an application time point of a data signal;

FIG. 8 is a view for explaining one example of a method for dividing data electrodes into a plurality of data electrode groups;

FIG. 9 is a view for explaining one example of another method for differentiating an application time point of a scan signal from an application time point of a data signal;

FIGS. 10a to 10b are views for explaining one example of a method for applying scan signals to scan electrodes using at least one scan type of a plurality of scan types which are different from each other in the order of applying scan signals to the scan electrodes;

FIG. 11 is a view for explaining another example of a method for applying scan signals to scan electrodes using at least one scan type of a plurality of scan types which are different from each other in the order of applying scan signals to the scan electrodes;

FIG. 12 is a view for explaining one example of a method for determining a scan type by block;

FIG. 13 is a view for explaining another example of a method for determining a scan type relative to a threshold value of the number of times of switching;

FIG. 14 is a view for explaining still another example of a method for applying scan signals to scan electrodes using at least one scan type of a plurality of scan types which are different from each other in the order of applying scan signals to the scan electrodes; and

FIG. 15 is a view for explaining one example of a method for determining a scan type in consideration of a subfield.

### DETAILED DESCRIPTION OF THE PREFERRED EMBODIMENTS

Embodiments of this document will be described in a more detailed manner with reference to the drawings.

A plasma display apparatus according to one embodiment of this document comprises: a plurality of scan electrodes; a plurality of sustain electrodes formed parallel to the scan electrodes; data electrodes intersecting the scan electrodes and the sustain electrodes; a scan driver for applying scan signals to the plurality of scan electrodes using a first scan type in a first subfield of an image frame and applying scan signals to the plurality of scan electrodes using a second scan type, which is different from the first scan type in the order of applying scan signals, in a second subfield thereof; a data driver for applying data signals to the data electrodes in phase with the scan signals during an address period and applying data signals to at least one of a plurality of data electrode groups each comprising at least one data electrode at a time point different from an application time point of a scan signal applied to the scan electrodes; and a sustain driver for applying to the sustain electrodes a first sustain bias signal, whose voltage is lower than that of a second sustain bias signal applied to the sustain electrodes during an address period, during a period starting from a set-down period of a reset period, which is earlier than the address period, before a scan signal is applied to the scan electrodes

Hereinafter, a plasma display apparatus and a driving method thereof according to one embodiment of this document will be described in detail with reference to the accompanying drawings.

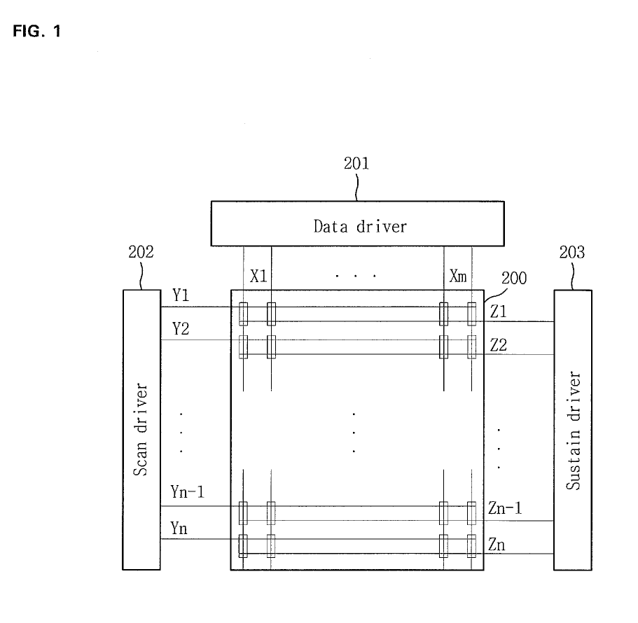

FIG. 1 is a view for explaining one example of the configuration of a plasma display apparatus according to one embodiment of this document.

Referring to FIG. 1, the plasma display apparatus according to one embodiment of this document comprises a plasma display panel 200, a data driver 201, a scan driver 202, and a sustain driver 203.

Although FIG. 1 illustrates the data driver 201, scan driver 202, and sustain driver 203 as being formed in different board shapes, respectively, at least two of the data driver 201, scan driver 202, and sustain driver 203 may be integrated in one board.

The plasma display panel 200 may comprise a front substrate (not shown) and a rear substrate (not shown) bonded to each other with a predetermined gap therebetween and a plurality of electrodes, including, for example, scan electrodes Y, sustain electrodes Z formed parallel to the scan electrodes Y, and data electrodes X intersecting the scan electrodes Y and the sustain electrodes Z.

The scan driver 202 applies a ramp-up signal Ramp-up and a falling ramp signal Ramp-down to the scan electrodes Y during a reset period. Also, the scan driver 202 applies a sustain signal SUS to the scan electrodes Y during a sustain period. Moreover, the scan driver 202 applies scan signals to the scan electrodes Y with respect to at least one scan type of a plurality of scan types, which are different from each other in the order of applying san signals to the plurality of scan electrodes Y, during an address period of an image frame. More specifically, in a subfield of an image frame, scan signals are applied to the plurality of scan electrodes Y using a first scan type, and in a second subfield thereof, scan signals are applied to the plurality of scan electrodes Y using a second scan type which is different from the first scan type in the order of applying scan signals.

The sustain driver 203 operates alternately with the scan driver 202 to apply a sustain signal SUS to the sustain electrodes Z during the sustain period. In the address period, a first sustain bias signal Vzb1 having a lower voltage than that of a second sustain bias signal Vzb2 applied to the sustain electrodes Z is applied to the sustain electrodes Z during a period starting from a set-down period of the reset period, which is earlier than the address period, before a scan signal, e.g., a first scan signal is applied to the scan electrodes Y.

The data driver 201 applies data signals to the data electrodes X under control of a timing controller (not shown). Also, the data driver 201 applies data signals to the data electrodes X in phase with the scan signals that the scan driver 202 applies to the scan electrodes Y. Moreover, in the address period of at least one of subfields of an image frame, the data driver 201 applies data signals to one or more of a plurality of data electrode groups comprising one or more data electrodes X at a time point different from an application time point of a scan signal applied to the scan electrodes by the scan driver 202.

The functions and operations of the scan driver 202, data driver 201, and sustain driver 203 of the plasma display apparatus according to one embodiment of this document will be more apparent through the following description.

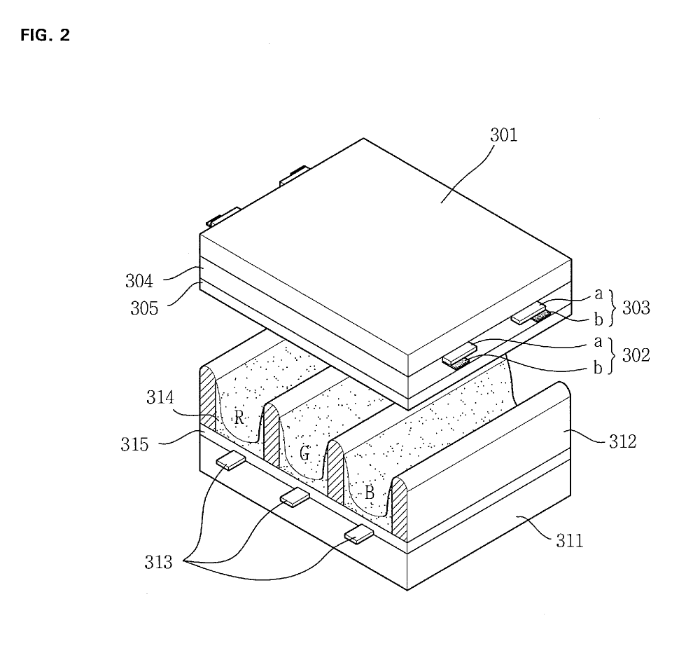

FIG. 2 is a view for explaining one example of the structure of a plasma display panel that may belong to a plasma display apparatus according to one embodiment of this document.

Referring to FIG. 2, the plasma display panel may comprise a front substrate 301 being a display surface on which an image is displayed, and a rear substrate 311 constituting a rear surface. Scan electrodes 302 (Y) and sustain electrodes 303 (Z) are formed in pairs on the front substrate 301, and a plurality of data electrodes 313 (X) intersecting the scan electrodes 302 (Y) and the sustain electrodes 303 (Z) are formed on the rear substrate 311.

The scan electrodes 302 (Y) and the sustain electrodes 303 (Z) are covered with one or more upper dielectric layers 304 to limit discharge current and provide insulation among the electrode pairs. A protection layer 305 for facilitating a discharge condition is formed on top of the upper dielectric layer 304. The protective layer 305 is formed by a method of depositing magnesium oxide (MgO) or the like.

On the other hand, electrodes, for example, data electrodes 213 (X) are formed on the rear substrate 311, and a dielectric layer, for example, a lower dielectric layer 315 for covering the data electrodes 313 (X) is formed on top of the rear substrate 311 where the data electrodes 313 (X) are formed.

The lower dielectric layer 315 can insulate the data electrodes 313 (X).

Barrier ribs 312 of a stripe type, well type, delta type, honeycomb type, etc. for defining discharge spaces, i.e., discharge cells, are formed on top of the lower dielectric layer 315. Accordingly, discharge cells of red (R), green (G), and blue (B) are formed between the front substrate 301 and the rear substrate 311.

In addition to the red (R), green (G), and blue (B) discharge cells, a white (W) or yellow (Y) discharge cell may be further formed.

Although the pitch of the red (R), green (G), and blue (B) discharge cells in the plasma display panel that may belong to the plasma display apparatus according to one embodiment of this document may be substantially the same with each other, the pitch of the red (R), green (G), and blue (B) discharge cells may be differentiated from each other in order to be consistent with a color temperature in the red (R), green (G), and blue (B) discharge cells.

In this case, the pitch may be differentiated for each of the red (R), green (G), and blue (B) discharge cells, or alternatively, the pitch of one or more of the red (R), green (G), and blue (B) discharge cells may be differentiated from the pitch of the other discharge cells. For instance, the pitch of the red (R) discharge cell may be the smallest, and the pitch of the green (G) and blue (B) discharge cells may be larger than the pitch of the red (R) discharge cell.

The pitch of the green (G) discharge cell may be substantially the same with or different from the pitch of the blue (B) discharge cell.

The plasma display panel that may belong to the plasma display apparatus according one embodiment of this document may have various forms of barrier rib structures as well as a structure of barrier ribs 312 as shown in FIG. 2. For instance, though not shown, the barrier ribs 312 comprises a first barrier rib and a second barrier rib intersecting each other, and may have a differential type barrier rib structure in which the height of the first barrier rib and the height of the second barrier rib are different from each other, a channel type barrier rib structure in which a channel useable as an exhaust path formed on one or more of the first and second barrier ribs, a hollow type barrier rib structure in which a hollow is formed on one or more of the first and second barrier ribs, and so on.

While the plasma display panel that may belong to the plasma display apparatus according to one embodiment of this document has been illustrated and described to have the red (R), green (G), and blue (B) discharge cells arranged on the same line, it is possible to arrange them in a different pattern. For instance, a delta type arrangement in which the red (R), green (G), and blue (B) discharge cells are arranged in a triangle shape may be applicable. Further, the discharge cells may have a variety of polygonal shapes such as pentagonal and hexagonal shapes, as well as a rectangular shape.

A discharge gas is filled in the discharge cells defined by the barrier ribs 312. For instance, a discharge gas, such as xenon (Xe) or Argon (Ar) is filled therein.

Moreover, a phosphor layer 314 for emitting visible light for image display upon address charge may be formed in the discharge cells defined by the barrier ribs 312. For instance, red (R), green (G) and blue (B) phosphor layers may be formed therein.

A white (W) phosphor layer and/or a yellow (Y) phosphor layer may be further formed in addition to the red (R), green (G) and blue (B) phosphors.

The thickness (width) of the phosphor layers 314 of the red (R), green (G) and blue (B) discharge cells may be substantially the same, or the thickness of one or more of them may be different from the thickness of the others. For instance, if the thickness of the phosphor layer 314 in at least one of the red (R), green (G) and blue (B) discharge cells is different from the thickness of the other discharge cells, the thickness of the phosphor layer 314 in the blue (B) discharge cell may be greater than the thickness of the phosphor layer 314 in the red (R) discharge cell. The thickness of the phosphor layer 314 in the green (G) discharge cell may be substantially the same with or different from the thickness of the phosphor layer 314 in the blue (B) discharge cell.

For the purpose of emitting light generated in the discharge cells to the outside and attaining driving efficiency, the first electrodes 302 (Y) and the second electrodes 303 (Z) may comprises bus electrodes (b) made of opaque metal, such as silver (Ag) and transparent electrodes (a) made of transparent material, such as Indium Tin Oxide (ITO).

In this manner, by configuring the first electrodes 302 (Y) and the second electrodes 303 (Z) as comprising transparent electrodes (a), visible light generated in the discharge cells can be emitted more effectively upon being emitted out of the plasma display panel.

Moreover, in the case that the first electrodes 302 (Y) and the second electrodes 303 (Z) comprises transparent electrodes (a) alone, the driving efficiency may be reduced because the electrical conductivity of the transparent electrodes is relatively low. On the other hand, in the case that that the first electrodes 302 (Y) and the second electrodes 303 (Z) comprises bus electrodes (b) alone, a low electrical conductivity of the transparent electrodes (a), which may cause a reduction in driving efficiency, can be compensated for.

It should be noted that only one example of the plasma display panel that may belong to in the plasma display apparatus according to this document has been illustrated and described above, and this document is not limited to the plasma display panel of the above-described structure. For instance, although the above description illustrates a case where the upper dielectric layer of reference numeral 304 and the lower dielectric layer of reference numeral 315 are a single layer, respectively, one or more of the upper dielectric layer and the lower dielectric layer may be formed in a plurality of layers.

Moreover, a black layer (not shown) for absorbing external light may be further formed on top of the barrier ribs 312 in order to prevent the external light from being reflected by the barrier ribs of reference numeral 312.

Alternatively, a black layer (not shown) may be further formed at specific positions on the front substrate 301 corresponding to the barrier ribs 312.

Although the width or thickness of the data electrodes 313 formed on the rear substrate 311 may be substantially the same, the width or thickness inside the discharge cells may be different from the width or thickness outside the discharge cells. For instance, the width or thickness inside the discharge cells may be greater than that outside the discharge cells.

In this way, the structure of the plasma display panel that may belong to the plasma display apparatus according to one embodiment of this document can be changed in various ways.

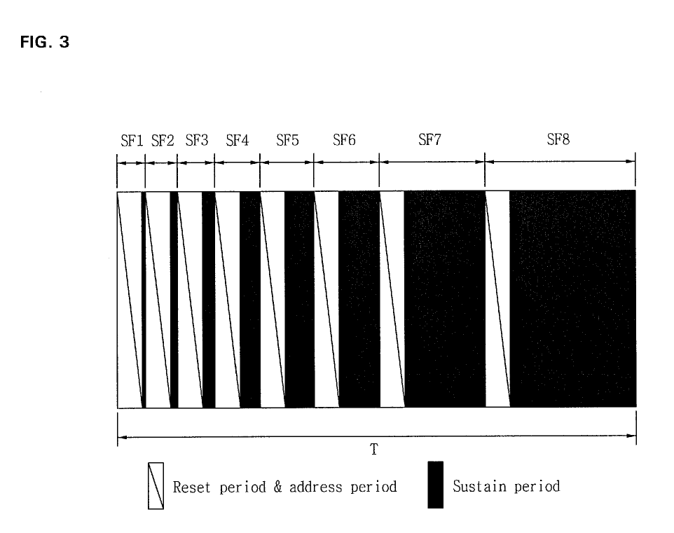

FIG. 3 is a view for explaining one example of a method for implementing gray levels of an image in a plasma display apparatus according to one embodiment of this document.

Referring to FIG. 3, in the plasma display apparatus according to one embodiment of this document, an image frame is divided into several subfields having a different number of times of emission in order to implement gray levels of an image. Each subfield is subdivided into a reset period for initializing the discharge cells, an address period for selecting a discharge cell to be discharged, and a sustain period for implementing gray levels depending on the number of discharges.

For example, to display images with 256 gray levels, one image frame is divided into, for example, eight subfields SF1 to SF8, as shown in FIG. 3. Each of the eight subfields SF1 to SF8 is again divided into a reset period, an address period and a sustain period.

The sustain period is a period for determining a weighted gray value in each subfield. For example, in such a method of setting the weighted gray value of a first subfield to 2⁰ and the weighted gray value of a second subfield to 2₁, the weighted gray value of each subfield can be determined so that the weighted gray value increases in the ratio of 2ⁿ (where, n=0, 1, 2, 3, 4, 5, 6, 7) in each sub-field. As described above, gray levels of various images are represented by controlling the number of sustain signals applied during the sustain period of each subfield depending on the weighted gray level during the sustain period in each subfield.

The plasma display apparatus according to one embodiment of this document uses a plurality of image frames in order to implement an image, for example, in order to display an image for one second. For instance, in order to display an image for one second, 60 image frames can be used. In this case, the length of one image frame may be 1/60 seconds, i.e., 16.67 ms.

Although FIG. 3 has illustrated and described a case in which one image frame consists of eight subfields, the number of subfields constituting one image frame may be varied. For instance, one image frame may consist of twelve subfields, from the first subfield to the twelfth subfield, or one image frame may consist of 10 subfields.

Although in FIG. 3 the subfields are arranged in one image frame in the order of increasing a weighted gray level, the subfields may be arranged in one image frame in the order of decreasing a weighted gray level, or the subfields may be arranged regardless of a weighted gray level.

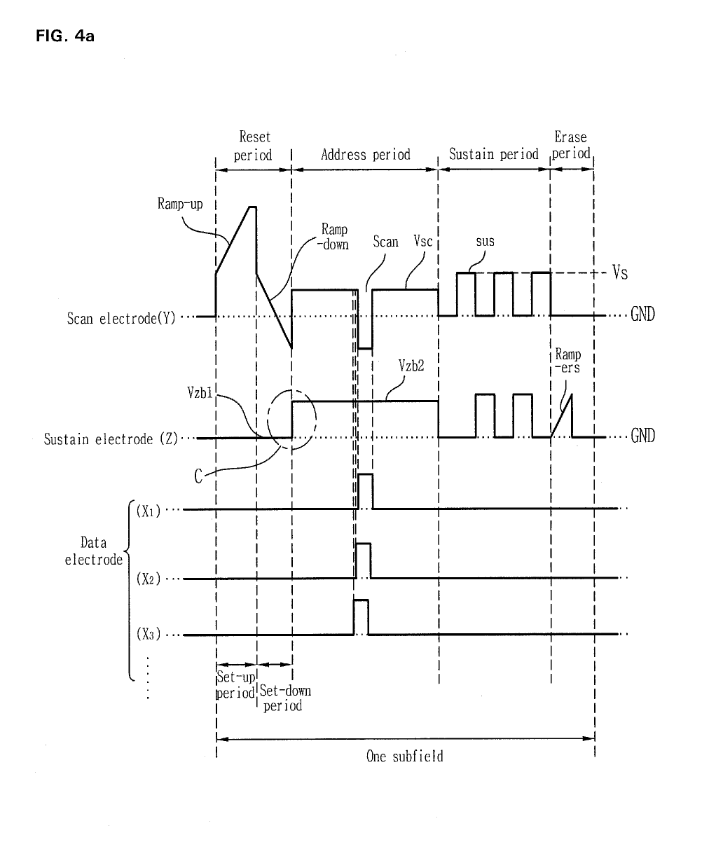

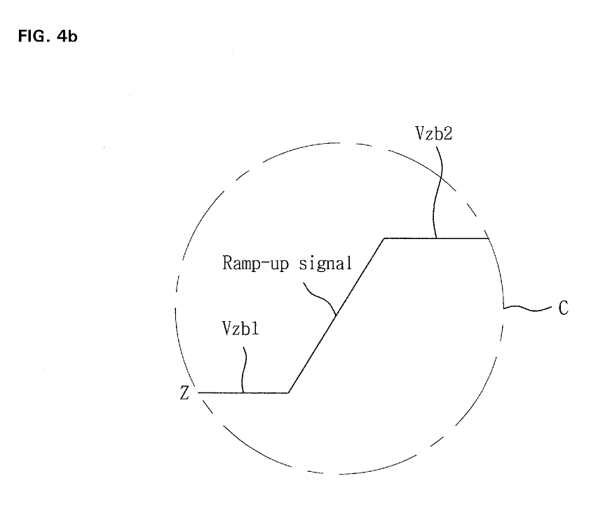

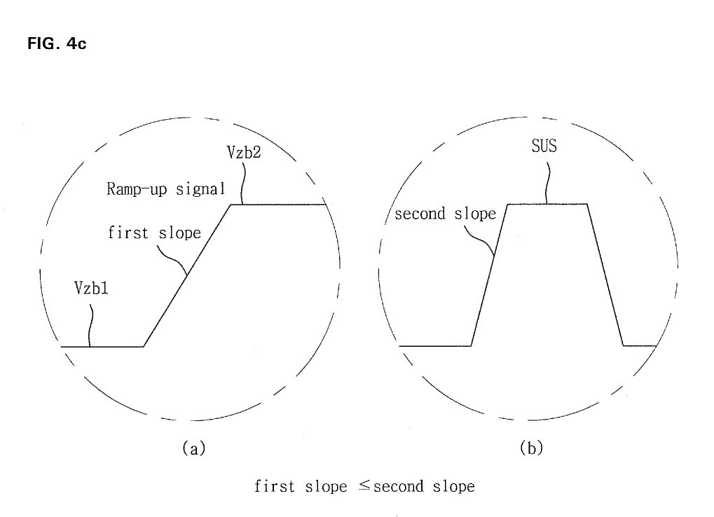

FIGS. 4a to 4c are views for explaining one example of the operation of a plasma display apparatus according to one embodiment of this document.

First, referring to FIG. 4a, in a set-up period of the reset period, the scan driver of reference numeral 202 of FIG. 1 applies a ramp-up signal to the scan electrodes Y. The ramp-up signal generates a weak dark discharge within the discharge cells. The set-up discharge causes positive wall charges to be accumulated on the data electrodes X and the sustain electrodes Z, and negative wall charges to be accumulated on the scan electrodes Y.

In a set-down period, after the ramp-up signal is applied, the scan driver of reference numeral 202 of FIG. 1 applies a ramp-down signal, which falls from a positive voltage that is less than a peak voltage of the ramp-up signal to a predetermined voltage level that is less than a ground (GND) level voltage. Accordingly, a weak erase discharge is generated within the cells, thus partially erasing wall charges excessively formed on the scan electrodes. The set-down discharge causes wall charges of the degree in which an address discharge can be stably generated to uniformly remain within the discharge cells.

In the address period, the scan driver of reference numeral 202 of FIG. 1 applies a scan signal, which falls from a scan reference voltage Vsc, to the scan electrodes Y. The data driver of reference numeral 201 of FIG. 1 applies a data signal to the data electrodes X in synchronization with the scan signal. An application time point of a scan signal applied to the scan electrodes Y and an application time point of a data signal applied to the data electrodes X are different from each other. The differentiation between the application time point of a scan signal and the application time point of a data signal will be more apparent through the following description.

As a voltage difference between the scan signal and the data signal and a wall voltage generated in the reset period are added together, an address discharge is generated within discharge cells to which the data signal is applied. Wall charges of the degree in which a discharge can be generated when a sustain voltage Vs is applied are formed within discharge cells selected by the address discharge. During the set-down period of the reset period and the address period, the sustain driver of reference numeral 203 of FIG. 1 applies a positive bias signal to the sustain electrodes such that an erroneous discharge is not generated between the sustain electrodes and the scan electrodes. For example, in the address period, a second sustain bias voltage Vzb2 is applied to the sustain electrodes Z, and during a period starting from the set-down period of the reset period, which is earlier than the address period, before a scan signal, e.g., a first scan signal is applied to the scan electrodes Y, a first sustain bias signal Vzb1 having a lower voltage than the second sustain bias voltage Vzb2 is applied to the sustain electrodes Z.

A voltage of the first sustain bias signal Vzb1 is less than a voltage of the second sustain bias signal Vzb2, and greater than or the same as a ground (GND) level voltage. Alternatively, in the set-down period, in order to stabilize a voltage of the sustain electrodes, the voltage of the first sustain bias signal Vzb1 is set to a ground (GND) level voltage.

A voltage of the second sustain bias signal Vzb2 is less than or the same as a voltage Vs of a sustain signal SUS applied to at least one of the scan electrodes Y and the sustain electrodes Y in the sustain period subsequent to the address period.

As above, before a scan signal is applied to the scan electrodes Y, the first sustain bias signal Vzb1 is applied to the sustain electrodes Z, so that the wall charges in the discharge cells in the set-down period are prevented from being excessively erased, thereby sufficiently securing the amount of wall charges participating in an address discharge when the address discharge occurs.

As the amount of wall charges participating in an address discharge when the discharge occurs is sufficiently secured, the address jitter characteristics are improved, thereby enabling a high-speed driving of the plasma display apparatus. In other words, a single scan method for scanning the entire panel with one driving unit can be applied.

In the sustain period, the scan driver of reference numeral 202 of FIG. 1 and the sustain driver of reference numeral 203 alternately apply a sustain signal SUS to the scan electrodes Y and the sustain electrodes Z. As a wall voltage within the discharge cells and the sustain signal are added together, a sustain discharge, i.e., a display discharge is generated between the scan electrodes and the sustain electrodes in the discharge cells selected by the address discharge whenever the sustain signal is applied.

In the erase period, the sustain driver of reference numeral 203 of FIG. 1 applies an erase ramp signal Ramp-ers having a smaller pulse width and a lower voltage level than the sustain signal to the sustain electrodes Z, thereby sufficiently erasing wall charges remaining within the discharge cells.

The erase period can be omitted from at least one of a plurality of subfields of an image frame.

Next, referring to FIG. 4b, after the first sustain bias signal Vzb1 is applied to the sustain electrodes Z, a rising signal, whose voltage gradually rises from the voltage of the first sustain bias signal Vzb1 to the voltage of the second sustain bias signal Vzb2, is applied to the sustain electrodes Z. That is, the rising signal is applied to the sustain electrodes Z between the first sustain bias signal Vzb1 and the second sustain bias signal Vzb2.

As above, after the application of the first sustain bias signal Vzb1, when a rising signal, whose voltage gradually rises, is applied to the sustain electrodes (Z), the rate of voltage change per unit time decreases, thereby reducing the effect of coupling through capacitance of the panel. As a result, the generation of noise can be reduced.

Next, referring to FIG. 4c, the slope of a rising signal may be set to be slower as compared to the slope of the sustain signal.

For example, a slope, i.e., a first slope, at which the voltage of the rising signal rises from the voltage of the first sustain bias signal Vzb1 to the voltage of the second sustain bias voltage Vzb2 as shown in (a), may be slower than a slope, i.e., a second slope, at which the sustain signal applied to at least either of the scan electrodes Y and the sustain electrodes Z in the sustain period subsequent to the address period rises as shown in (b)

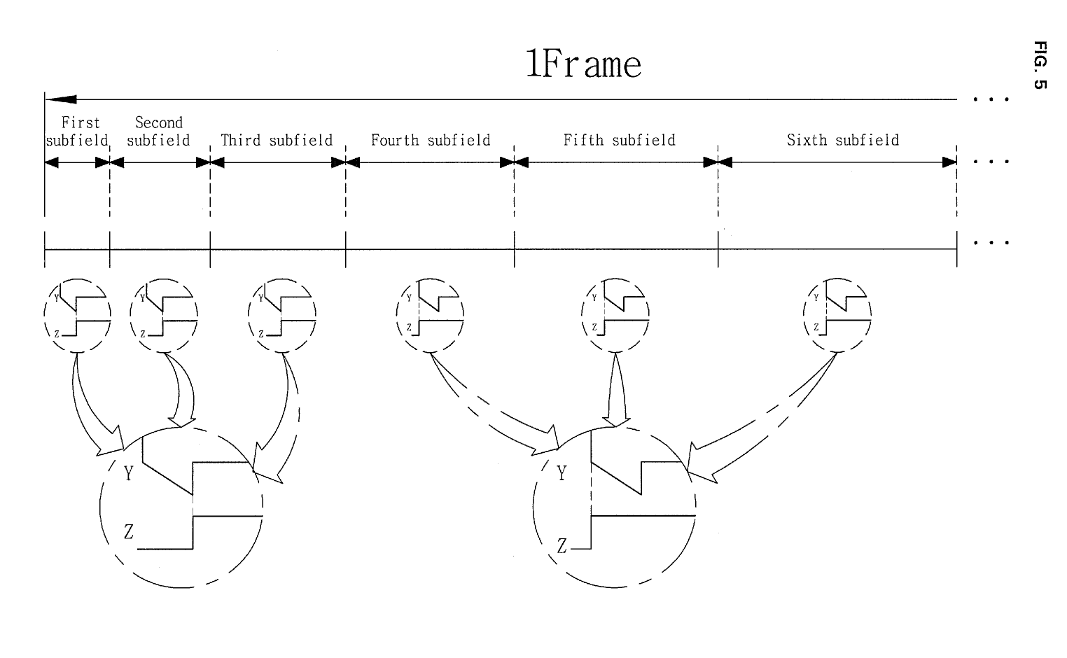

FIG. 5 is a view for explaining one example of another method for applying a sustain bias signal.

Referring to FIG. 5, in the address period of the first, second, and third subfields among the subfields of an image frame, the first sustain bias signal Vzb1 is applied to the sustain electrodes Z during a period starting from a set-down period of a reset period before a scan signal is applied to the scan electrodes. In the other subfields, the second sustain bias signal Vzb2 is applied to the sustain electrodes Z in the set-down period. The first, second, and third subfields may be subfields having a relatively low weighted gray level among the plurality of subfields of an image frame.

The first sustain bias signal Vzb1 is applied to the sustain electrodes Z during a period starting from a set-down period of a reset period of a predetermined subfield, for example, a subfield having a relatively low weighted gray level, in one image frame, before a scan signal is applied to the scan electrodes, because the subfield having a relatively low weighted gray level may increase the possibility of making an overall discharge unstable due to a relatively small number of sustain signals applied to at least one of the scan electrodes Y and the sustain electrodes Z during the sustain period. In other words, wall charges within the discharge cells are prevented from being excessively erased in the set-down period by applying the first sustain bias signal Vzb1 during a period starting from the set-down period before a scan signal is applied to the scan electrodes Y, thereby stabilizing a discharge in the subfields having a relatively small number of sustain signals and a relatively small weighted gray level.

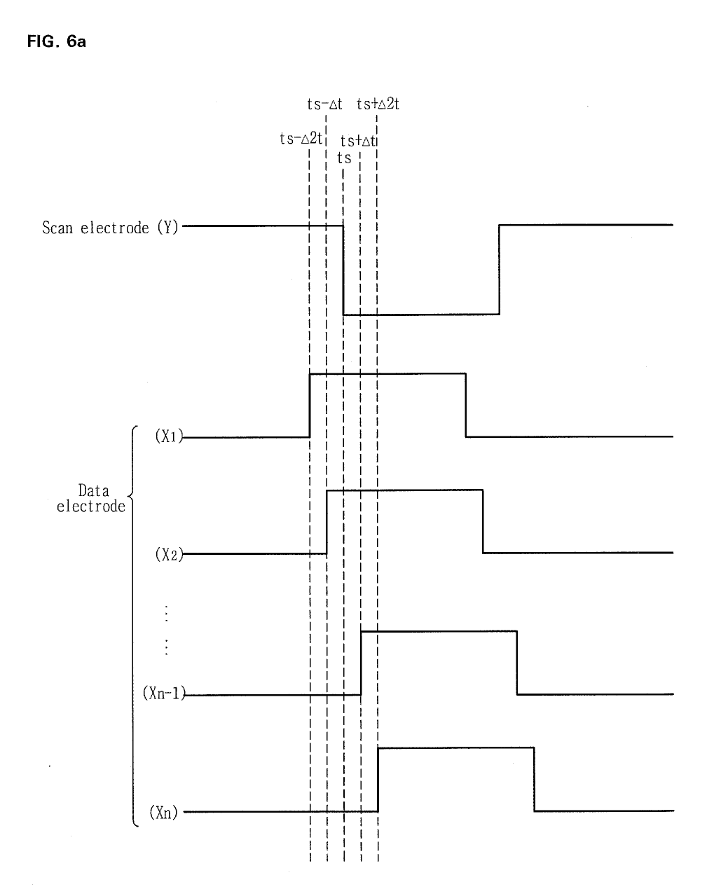

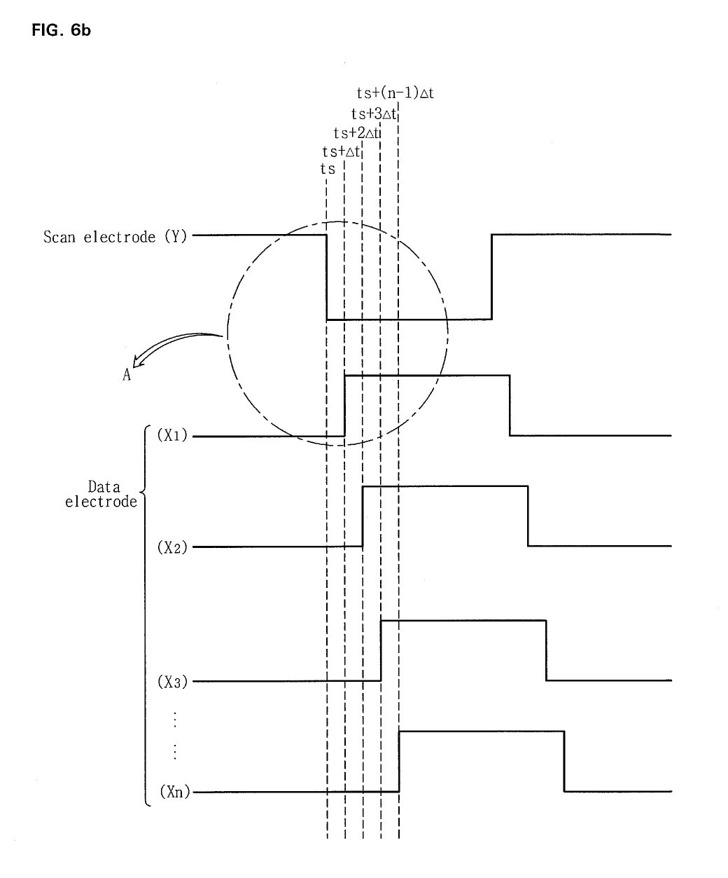

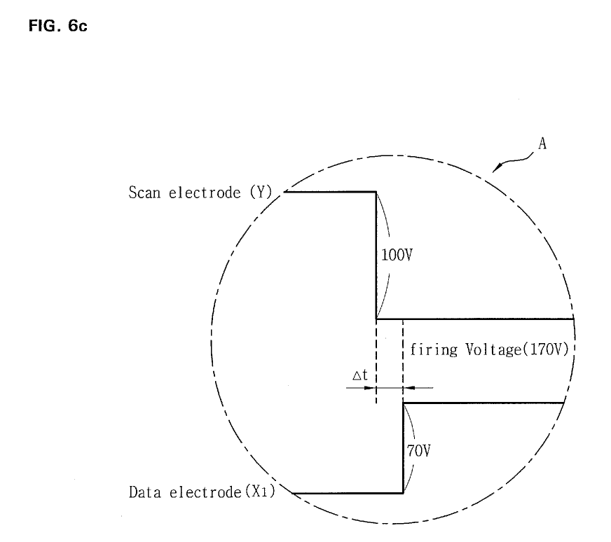

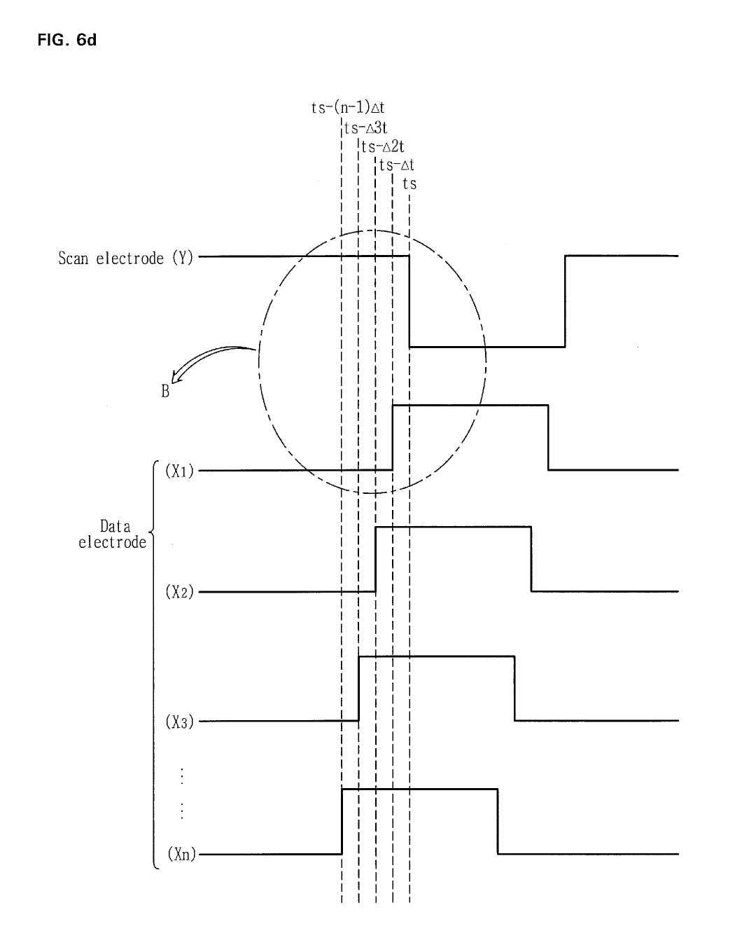

FIGS. 6a to 6d are views for explaining one example of a method for differentiating an application time point of a scan signal from an application time point of a data signal in a plasma display apparatus according to one embodiment of this document.

First, referring to FIG. 6a, in the plasma display apparatus according to one embodiment of this document, an application time point of a scan signal applied to the scan electrodes Y is differentiated from an application time point of a data signal applied to the data electrodes X. For example, assuming that the application time point of the scan signal to the scan electrode Y is ts, then a data signal is applied to the data electrode X₁ according to the arrangement of the data electrodes X₁˜Xn prior to the application time point of a scan signal to the scan electrode Y by 2 Δt, or at the time point, ts−2 Δt. Further, a data signal is applied to the data electrode X₂ prior to the application time point of a scan signal to the scan electrode Y by Δt, or at the time point, ts−Δt. Likewise, at the time point ts+Δt, a data signal is applied to the X(n−1) electrode, and at ts+2 Δt, a data signal is applied to the X(n) electrode. That is, the data signals applied to the data electrodes X₁˜Xₙ are staggered before and after the scan signal is applied to the scan electrode Y.

Next, referring to FIG. 6b, unlike FIG. 6a, the all the data signal may be applied after the scan signal. Although in FIG. 6b, the application time point of all the data signals applied to the are set to be delayed with respect to the application time point of the scan signal, it is possible to change the number of data signals applied later than the application time point of a scan signal, including setting only the application time point of one data signal to be delayed with respect to the application time point of a scan signal. The generation of a discharge as shown in FIG. 6b will be described below with reference to FIG. 6c.

Referring to FIG. 6c, for example, assuming that the firing voltage of an address discharge is 170V, the scan signal voltage is 100V, and the data signal voltage 70V, in the region A, first, due to the scan signal applied to the scan electrode Y, the voltage difference between the scan electrode Y and the data electrode X₁ becomes 100V. Then, some time, Δt, after application of the scan signal, a data signal is applied to the data electrode X₁, increasing the voltage difference between the scan electrode Y and the data electrode X₁ from 100V to 170V. The increased voltage difference between the scan electrode Y and the data electrode X₁ becomes a discharge firing voltage and thus an address discharge is generated between the scan electrode Y and the data electrode X_{1.}

Next, referring to FIG. 6d, unlike FIG. 6a or 6b, all the data signals may precede the scan signal applied to the scan electrode Y. Although in FIG. 6d, the application time point of the data signals are set to precede the application time point of the scan signal, it is possible to change the number of data signals applied earlier than the application time point of a scan signal, including setting only the application time point of one data signal to be precede the application time point of a scan signal.

A difference in application time point between a data signal and a scan signal may be substantially the same or different. For example, if the application time point of the scan signal applied to the scan electrode Y is marked as ts, and the time difference between the application time point of the scan signal and the application time point of the nearest data signal is Δt, the difference between the application time point of the scan signal and an application time point of the second nearest data signal is two times Δt, i.e., 2 Δt. That is, the difference in application time point between the first data signal and the scan signal and the difference in application time point between the second data signal and the scan signal may be substantially the same. If the application time point of the scan signal applied to the scan electrode Y is marked as ts, and the time difference between the application time point of the scan signal and the application time point of the nearest data signal is Δt, the difference between the application time point of the scan signal and an application time point of the second nearest data signal is three times Δt, i.e., 3 Δt. That is, the difference in application time point between the first data signal and the scan signal and the difference in application time point between the second data signal and the scan signal may be substantially different.

Taking into account defined length of the address period, the difference between the application time point of a scan signal and the application time point of a data signal can be set to be above 10 nano seconds (ns) and below 1,000 nano seconds (ns). Furthermore, considering the pulse width of a predetermined scan signal, the difference between the application time point of a scan signal and the application time point of a data signal can be set to be below the width of a predetermined scan signals and above 1/100 of the width of the predetermined scan signals.

Alternatively, it is possible to make an application time point of data signals different from each other, as well as making an application time point of a scan signal and an application time point of a data signal. For instance, an application time point of a scan signal applied to the scan electrodes Y can be marked as ts, an application time point of one data signal can be marked as ts+Δt, an application time point of another data signal can be marked as ts+2 Δt, and an application time point of still another data signal can be marked ts+3 Δt.

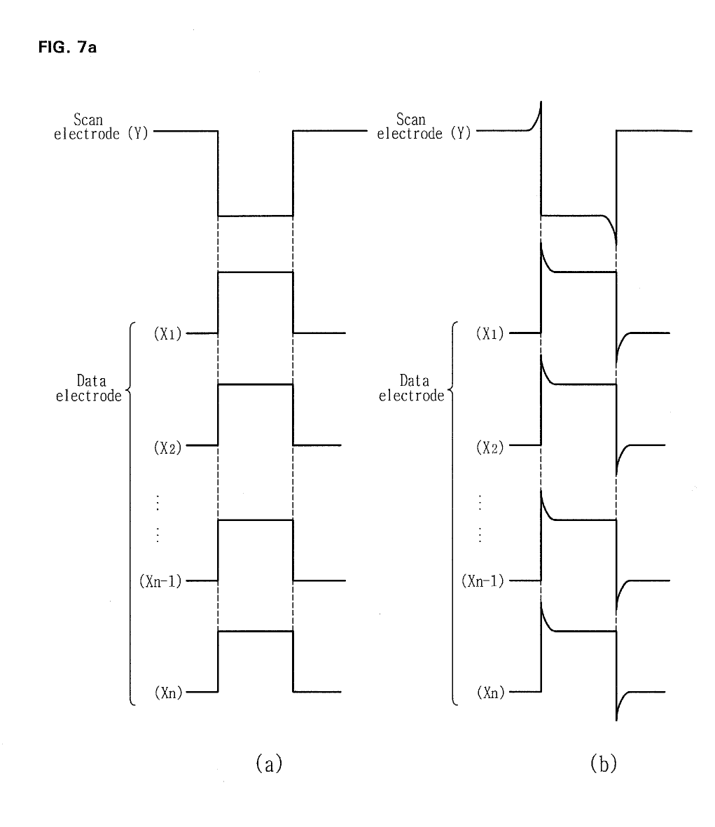

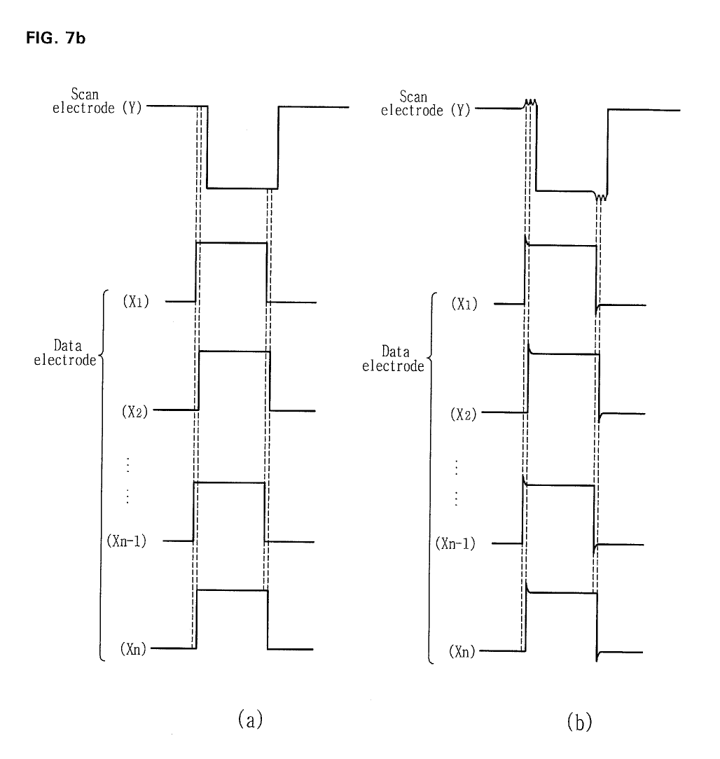

FIGS. 7a and 7b are views for explaining the reason for differentiating an application time point of a scan signal from an application time point of a data signal.

First, referring to FIG. 7a, unlike one embodiment of this document, there is a case where an application time point of a scan signal applied to the scan electrode Y and an application time point of a data signal applied to the data electrode in the address period are the same.

For instance, as shown in (a), if application time points of a scan signal applied to the scan electrode Y and of a data signal applied to the data electrode in the address period are both set to ts, a relatively large noise as shown in (b) may be generated. This noise results from coupling through capacitance of the panel. At a time point when the voltage of the data signal abruptly rises, an up noise is generated, and at a time point when the voltage of the data signal abruptly falls, a down noise is generated.

As the application time points of a scan signal and a data signal are the same, the generated noise causes a drawback of instabilizing the address discharge generated in the address period, thereby reducing a driving efficiency of the plasma display apparatus.

Next, referring to FIG. 7b, there is shown a case in which application time points of a data signal and of a scan signal are different.

For instance, if a data signal is applied to the data electrodes X at a point of time different from the application time point of a scan signal applied to the scan electrodes Y, as shown in (b), the size of a generated noise is reduced as compared to the case of (b) of FIG. 7a.

This reduces the effect of coupling through capacitance of the panel at an application time point of a data signal applied to the data electrodes X. As a result, the address discharge generated in the address period is stabilized, thereby suppressing the reduction of the driving stability of the plasma display apparatus.

Moreover, it is possible to apply a single scan method for scanning the entire panel with one driving unit by stabilizing the address discharge of a plasma display apparatus.

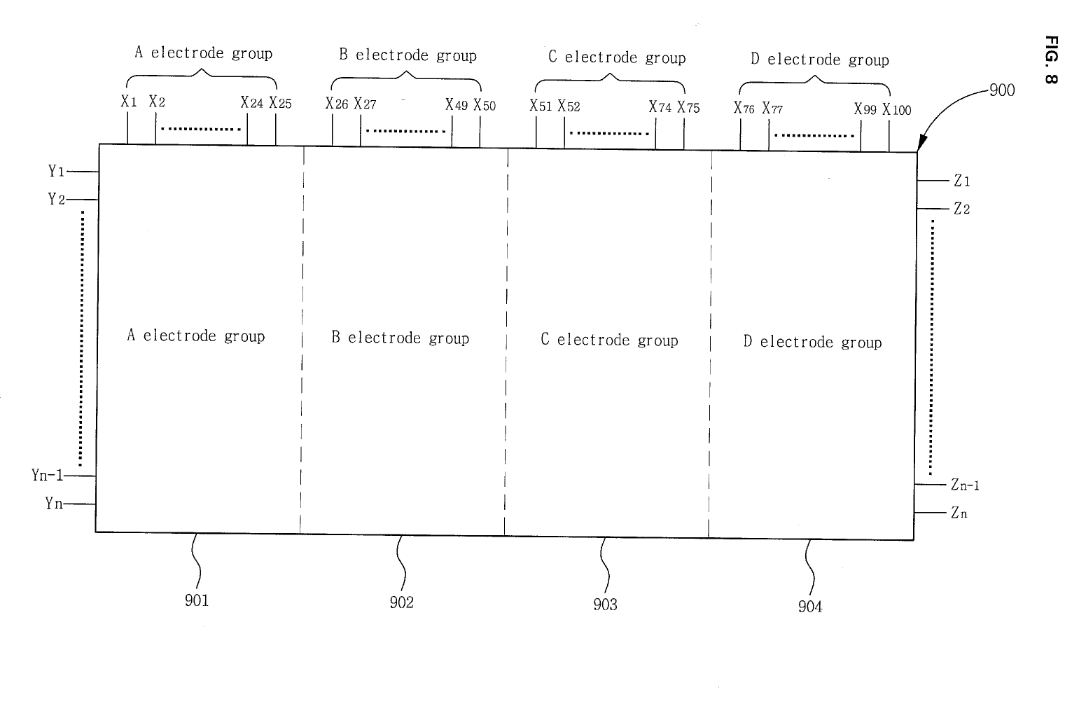

FIG. 8 is a view for explaining one example of a method for dividing data electrodes into a plurality of data electrode groups.

Referring to FIG. 8, the data electrodes can be divided into a plurality of data electrode groups comprising one or more data electrode.

For instance, if a total number of data electrodes is 100, i.e., the data electrodes comprises data electrodes X1 to X100, the data electrodes X1 to X25 are divided into an A data electrode group 901, the data electrodes X26 to X50 are divided into a B data electrode group 902, the data electrodes X51 to X75 are divided into a C data electrode group 903, and the data electrodes X76 to X100 are divided into a D data electrode group 904.

In FIG. 8, the number of data electrodes belonging to each data electrode group 901, 902, 903, and 904 is the same, however, the number of data electrodes belonging to each group 901, 902, 903, and 904 may differ between groups. For instance, the A data electrode group comprises 20 data electrodes, the B data electrode group comprises 20 data electrodes, the C data electrode group comprises 30 data electrodes, and the D data electrode group comprises 30 data electrodes. When the total number of data electrodes is assumed to be M, the number of the data electrodes belonging to the data electrode groups can be set to be more than 1 and below (M−1). Also, the number of data electrode groups can be adjusted. Moreover, when the total number of data electrodes is assumed to be M, the number of the data electrode groups can be set to be more than two and less than the total number, M, of data electrodes.

When adapting the concept of data electrode groups in FIG. 8 to the case of FIGS. 6a to 6d, the data electrode groups the case in FIGS. 6a to 6d comprises one data electrode, respectively.

Although FIG. 8 illustrates only one example of a method for dividing one or more data electrodes adjacent to each other into several data electrode groups, it is possible to vary the method of division into data electrode groups, including grouping odd-numbered data electrodes of the plurality of data electrode groups into an odd-numbered data electrode group and grouping even-numbered data electrodes thereof into an even-numbered data electrode group.

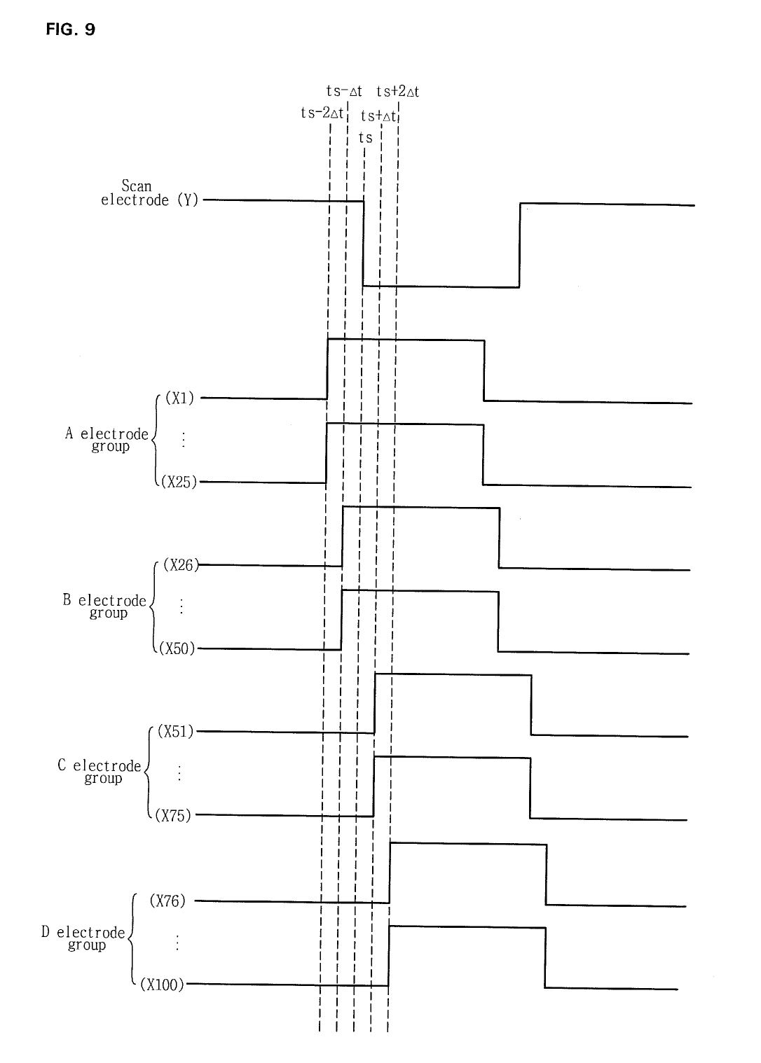

FIG. 9 is a view for explaining one example of another method for differentiating an application time point of a scan signal from an application time point of a data signal.

Referring to FIG. 9, a data signal is applied to at least one of a plurality of data electrode groups comprising at least one data electrode in the address period at a point of time different from an application time point of a scan signal applied to the scan electrodes Y.

For instance, like the foregoing FIG. 8, data electrodes are divided into a total of four data electrode groups, i.e., A, B, C, and D data electrode groups. Assuming that the application time point of the scan signal applied to the scan electrode Y is ts, a data signal is applied to the A data electrode group comprising X₁ to X₂₅ data electrodes at a point of time prior to the application time point of the scan signal by 2 Δt, i.e., at the time point ts−2 Δt. Further, a data signal is applied to the B data electrode group comprising X₂₆ to X₅₀ data electrodes at a point of time prior to the application time point of the scan signal to the scan electrode Y by Δt, i.e., at the time point ts−Δt. Likewise, at the time point ts+Δt, a data signal is applied to the C data electrode group comprising X₅₁ to X₇₅ data electrodes, and at ts+2 Δt, a data signal is applied to the D data electrode group comprising X₇₆ to X₁₀₀ data electrodes.

Taking into account defined length of the address period, the difference between the application time points of a data signal to the plurality of data electrode groups and the difference between the application time point of the data signal applied to at least one data electrode group and the application time point of the scan signal applied to the scan electrode can be set to be above 10 nano seconds (ns) and below 1,000 nano seconds (ns). Furthermore, considering the pulse width of a predetermined scan signal, the difference between the application time points of a data signal to the plurality of data electrode groups and the difference between the application time point of the data signal applied to at least one data electrode group and the application time point of the scan signal applied to the scan electrode can be set to be below the width of a predetermined scan signal and above 1/100 of the width of the predetermined scan signal.

As above, the method for differentiating an application time point of a scan signal from an application time point of a data signal has been descried in detail in FIGS. 6a to 6d, so repetitive description will be omitted.

Meanwhile, it is possible to differentiate the application time point of a scan signal and the application time point of a data signal selectively in at least one of a plurality of subfields of an image frame. For example, it is assumed that one image frame comprises a total of twelve subfields, i.e., from first to twelfth subfields. The application time point of the scan signal and the application time point of the data signal are different in the first, second, third, fourth, and fifth subfields, and the application time points of the scan signal and the data signal are approximately the same in the remaining sub-fields.

Alternatively, in at least one of the plurality of subfields of the image frame, the application time point of the scan signal and the application time point of the data signal may be varied from each other in a different method from that of the other subfields. For example, in at least one subfield of the subfields in one image frame, the application time points of the scan signal and the data signal may be varied in the method as shown in the foregoing FIG. 6a, and in the other subfields, the application time points of the scan signal and the data signal may be varied in the method as shown in the foregoing FIG. 6b.

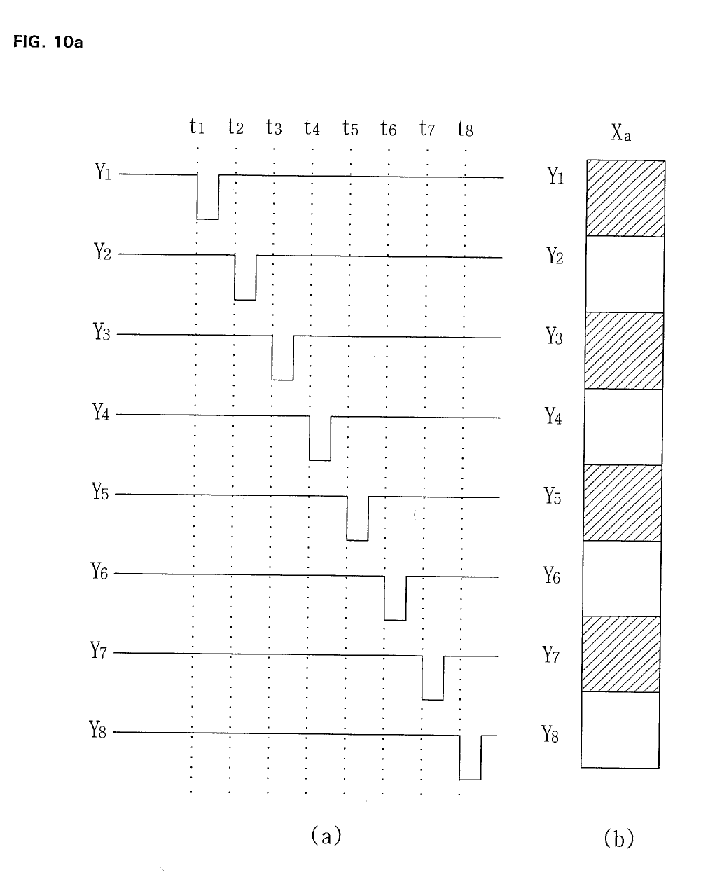

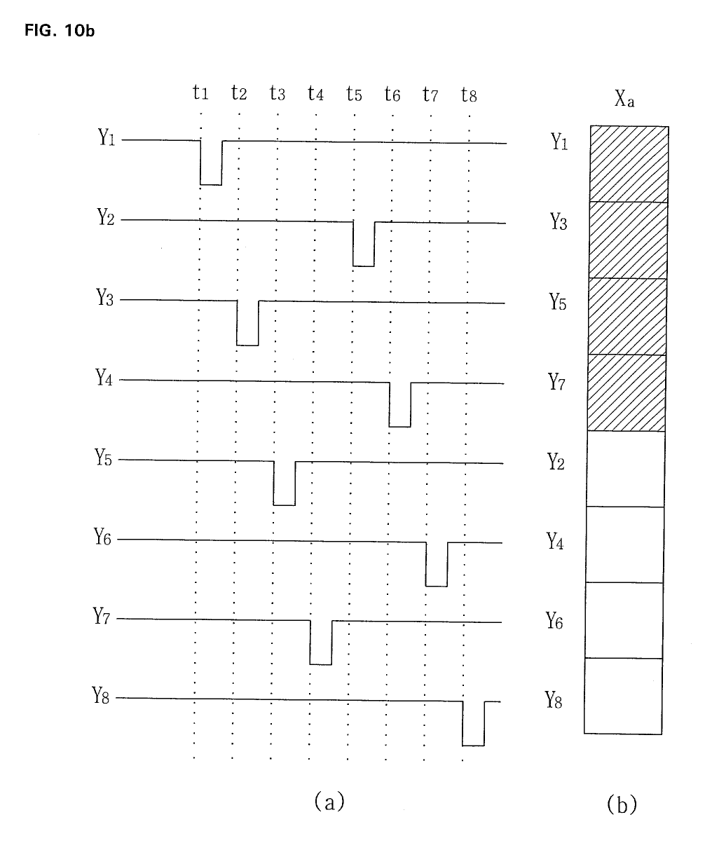

FIGS. 10a to 10b are views for explaining one example of a method for applying scan signals to scan electrodes using at least one scan type of a plurality of scan types which are different from each other in the order of applying scan signals to the scan electrodes.

First, referring to FIG. 10a, the method for sequentially applying scan signals to the first scan electrode Y1 through the eighth scan electrode Y8. In this case, it is assumed that data with a repeating pattern of high and low voltage levels is supplied as shown in (b). For example, it is assumed that a data signal having a high voltage level is applied to the discharge cell arranged at a position where the Xa data electrode and the second scan electrode Y2 cross each other, the discharge cell arranged at a position where the Xa data electrode and the fourth scan electrode Y4 cross each other, the discharge cell arranged at a position where the Xa data electrode and the sixth scan electrode Y6 cross each other, and the discharge cell arranged at a position where the Xa data electrode and the eighth scan electrode Y8 cross each other, and no data signal having a low voltage level is applied to the discharge cells arranged at positions where the remaining first, third, fifth, and seventh scan electrodes Y1, Y3, Y5, and Y7 and the Xa data electrode cross each other.

In this case, the data driver for applying data signals has to consecutively perform on-off switching operations in order to apply data signals with a repeating pattern of high and low voltage levels. Accordingly, the number of times of switching operations of the data driver increases, thereby increasing the generation of a displacement current. Due to this, the possibility of an electrical damage to the driver increases. The number of times of switching of the data driver may be the number of changes in the voltage level of a data signal.

Next, referring to FIG. 10b, compared to the case of FIG. 10a, there is a case where the application orders of scan signals to the scan electrodes from the first scan electrode Y1 through the eighth scan electrode Y8 are different, and data with the same pattern is supplied. For example, it is assumed that a scan signal is applied in the order of the first, third, fifth, seventh, second, fourth, sixth, and eighth scan electrodes Y1, Y3, Y5, Y7, Y2, Y4, Y6, and Y8. That is, as compared to the foregoing FIG. 10a, the pattern of data is the same, and the scanning order, i.e., the application order of scan signals is different.

In this case, the driver for applying data signals consecutively applies a data signal having a high voltage level to the first, third, fifth, and seventh scan electrodes Y1, Y3, Y5, and Y7 during the application of a scan signal, and consecutively applies a data signal having a low voltage level to the second, fourth, sixth, and eighth scan electrodes Y2, Y4, Y6, and Y8 during the application of a scan signal.

Therefore, as shown in the case of the foregoing FIG. 10a, when applying a scan signal in the order of the first, second, third, fourth, fifth, sixth, seventh, and eighth scan electrodes Y1, Y2, Y3, Y4, Y5, Y6, Y7, and Y8, the data driver has to perform a total of seven times of switching operations. On the other hand, as shown in FIG. 10b, when applying a scan signal in the order of the first, third, fifth, seventh, second, fourth, sixth, and eighth scan electrodes Y1, Y3, Y5, Y7, Y2, Y4, Y6, and Y8, the data driver has to perform only one time of switching operation. Accordingly, in the case of FIG. 10b, the magnitude of the displacement current generated in the data driver is reduced. As a result, it is possible to prevent an electrical damage to the driver.

By using the method as shown in FIG. 10b, the magnitude of the displacement current generated in the data driver can be reduced. Thus, it is possible to apply a single scan method for scanning the entire panel with one driving unit by stabilizing the address discharge of a plasma display apparatus.

Although a scan type has been so far applied in consideration of only the number of changes in the voltage level of a data signal applied to one data electrode, it is possible to apply a scan type in consideration of the difference in voltage level of a data signal applied to two or more adjacent data electrodes.

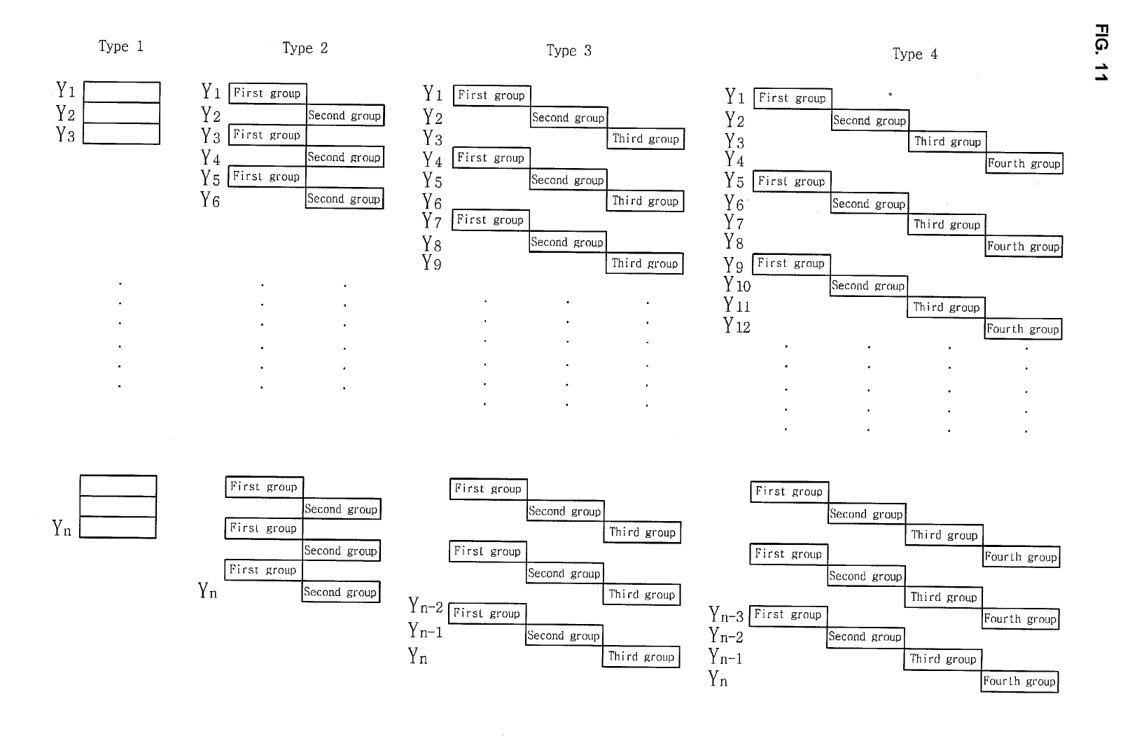

FIG. 11 is a view for explaining another example of a method for applying scan signals to scan electrodes using at least one scan type of a plurality of scan types which are different from each other in the order of applying scan signals to the scan electrodes.

Referring to FIG. 11, in the address period of an image frame, scan signals may be applied to scan electrodes using at least one scan type of a plurality of scan types which are different from each other in the order of applying scan signals to the scan electrodes.

For example, scanning can be performed, i.e., scan signals can be applied to the scan electrodes, using at least one scan type among the scan orders of a total of four scan types, e.g., a first type Type 1, a second type Type 2, a third type Type 3, and a fourth type Type 4.

The first scan type Type 1 may be a type for applying scan signals in the order of arrangement of the scan electrodes like the first, second, third, . . . scan electrodes Y1, Y2, Y3, . . . .

The second scan type Type 2 may be a type for consecutively scanning odd-numbered scan electrodes, i.e., consecutively applying scan signals to odd-numbered scan electrodes, and consecutively applying scan signals to even-numbered scan electrodes. For example, the second scan type Type 2 may be a type for applying scan signals in the order of the first, third, fifth, . . . (n−1)-th scan electrodes Y1, Y3, Y5, . . . (Yn−1), and applying scan signals in the order of the second, fourth, sixth, . . . n-th scan electrodes Y2, Y4, Y6, . . . Yn. The first, third, fifth, . . . (n−1)-th scan electrodes Y1, Y3, Y5, . . . (Yn−1) can be grouped into the scan electrodes of a first group, and the second, fourth, sixth, . . . n-th scan electrodes Y2, Y4, Y6, . . . Yn can be grouped into the scan electrodes of a second group.

The third scan type Type 3 consecutively applies scan signals to triple-numbered scan electrodes, i.e., 3a-th scan electrodes, or consecutively applies scan signals to (3a+1)-th scan electrodes, or consecutively applies scan signals to (3a+2)-th scan electrodes, wherein a is an integer greater than 0. For example, the third scan type Type 3 may be a type for applying scan signals in the order of the first, fourth, seventh, . . . (n−2)-th scan electrodes Y1, Y4, Y7, . . . (Yn−2), applying scan signals in the order of the second, fifth, eighth, . . . (n−1)-th scan electrodes Y2, Y5, Y7, . . . (Yn−1), and applying scan signals in the order of the third, sixth, ninth, . . . n-th scan electrodes Y3, Y6, Y9, . . . , Yn. The first, fourth, seventh, . . . (n−2)-th scan electrodes Y1, Y4, Y7, . . . (Yn−2) can be grouped into the scan electrodes of a first group, the second, fifth, eighth, . . . (n−1)-th scan electrodes Y2, Y5, Y7, . . . (Yn−1) can be grouped into the scan electrodes of a second group, and the third, sixth, ninth, . . . n-th scan electrodes Y3, Y6, Y9, . . . , Yn can be grouped into the scan electrodes of a third group.

The fourth scan type Type 4 consecutively applies scan signals to quadruple-numbered scan electrodes, i.e., 4b-th scan electrodes, or consecutively applies scan signals to (4b+1)-th scan electrodes, or consecutively applies scan signals to (4b+2)-th scan electrodes, or consecutively applies scan signals to (4b+3)-th scan electrodes, wherein b is an integer greater than 0. For example, the fourth scan type Type 4 may be a type for applying scan signals in the order of the first, fifth, ninth, . . . (n−3)-th scan electrodes Y1, Y5, Y9, . . . (Yn−3), applying scan signals in the order of the second, sixth, tenth, . . . (n−2)-th scan electrodes Y2, Y6, Y10, . . . (Yn−2), applying scan signals in the order of the third, seventh, eleventh, . . . (n−1)-th scan electrodes Y3, Y7, Y11, . . . , Yn−1, and applying scan signals in the order of the fourth, eighth, twelfth, . . . n-th scan electrodes Y4, Y8, Y12, . . . , Yn. The first, fifth, ninth, . . . (n−3)-th scan electrodes Y1, Y5, Y9, . . . (Yn−3) can be grouped in to the scan electrodes of a first group, the second, sixth, tenth, . . . (n−2)-th scan electrodes Y2, Y6, Y10, . . . (Yn−2) can be grouped into the scan electrodes of a second group, the third, seventh, eleventh, . . . (n−1)-th scan electrodes Y3, Y7, Y11, . . . , Yn−1 can be grouped into the scan electrodes of a third group, and the fourth, eighth, twelfth, . . . n-th scan electrodes Y4, Y8, Y12, . . . , Yn can be grouped into the scan electrodes of a fourth group.

For example, it is assumed that there are a first subfield and a second subfield that are different from each other. If the number of times of switching of the data driver with respect to the first scan type in the first subfield is smaller than the number of times of switching of the data driver with respect to the second scan type, scan signals can be applied to the plurality of scan electrodes using the first scan type Type 1 in the first subfield.

On the contrary, if the number of times of switching of the data driver with respect to the second scan type in the second subfield is smaller than the number of times of switching of the data driver with respect to the first scan type, scan signals can be applied to the plurality of scan electrodes using the second scan type Type 2 in the second subfield.

As above, different scan types may be applied in different subfields.

As explained above, the interval between two scan electrodes to which scan signals are consecutively applied can be kept approximately equal. For example, in the third type Type 3, among the first, fourth, and seventh scan electrodes Y1, Y4, and Y7 to which scan signals are applied in a consecutive order, the interval between the first scan electrode Y1 and the fourth scan electrode Y4 may be approximately the same as the interval between the fourth scan electrode Y4 and the seventh scan electrode Y7.

On the contrary, the interval between two scan electrodes to which scan signals are consecutively applied can be set different from each other. For example, scan signals can be consecutively applied to the first scan electrode Y1, the second scan electrode Y2, and the seventh scan electrode Y7. The interval between the first scan electrode Y1 and the second scan electrode Y2 is different from the interval between the second scan electrode Y2 and the seventh scan electrode Y7.

Although FIG. 11 has illustrated and described a total of four scan types and the method for selecting at least one of the four scan types and applying scan signals to scan electrodes Y in an order corresponding to the selected scan type, it is possible to provide various numbers of scan types, such as two scan types, three scan types, and five scan types, and use the method for selecting at least one of these scan types and applying scan signals to the scan electrodes Y in an order corresponding to the selected scan type.

As above, if scan signals are applied to the scan electrodes with respect to at least one of the plurality of scan types, scan signals can be applied to the scan electrodes using one scan type, in which the number of times of switching of the data driver in response to input image data is the smallest. For example, assuming that there is a total of four scan types as shown in FIG. 11, if the number of times of switching of the data driver corresponding to input image data is the smallest in the second scan type Type 2 among the first type Type 1, second type Type 2, third type Type 3, and fourth type Type 4, the second type Type 2 can be selected as the scan type corresponding to the input image data.

Alternatively, scan signals can be applied to scan electrodes using at least one of the plurality of scan types in which the number of times of switching of the data driver in response to input image data is below a threshold value. For example, assuming that there is a total of four scan types as shown in FIG. 11, if the number of times of switching of the data driver corresponding to input image data is below a threshold value in the second scan type Type 2 and third scan type Type 3 among the first type Type 1, second type Type 2, third type Type 3, and fourth type Type 4, at least one of the second type Type 2 and third scan type Type 3 can be selected as the scan type corresponding to the input image data. Here, the magnitude of the threshold value can be determined within a range of sufficiently protecting the driver from an electrical damage.

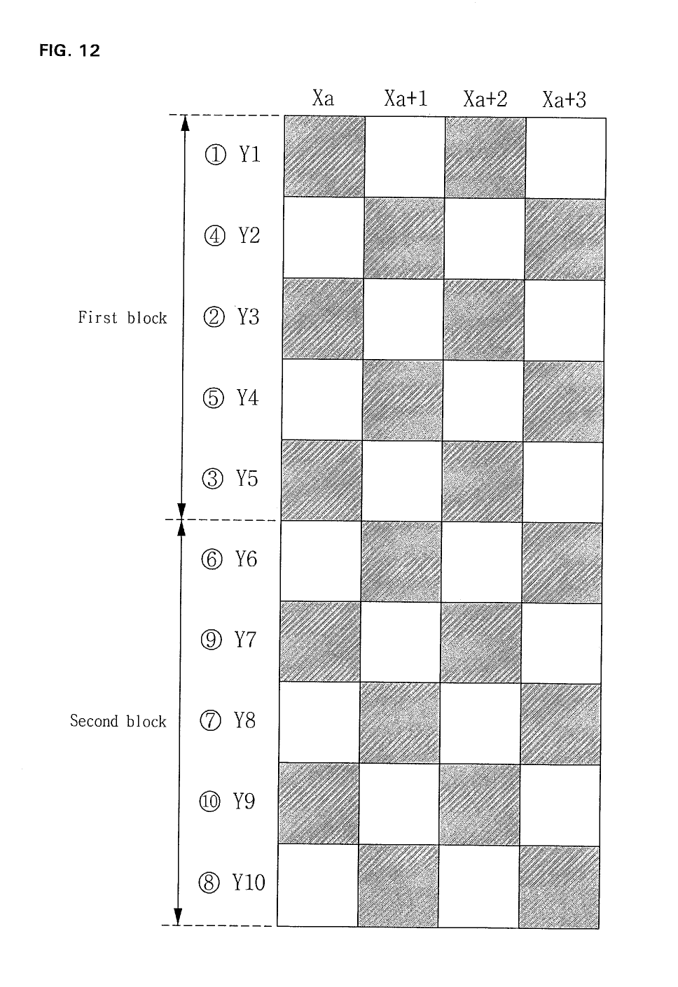

FIG. 12 is a view for explaining one example of a method for determining a scan type by block, wherein the numbers in the circles in indicate the application order of scan signals.

Referring to FIG. 12, in a first block comprising the first scan electrode Y1 through the fifth scan electrode Y5, scan signals are consecutively applied to the first, third, fifth, second, and fourth scan electrodes Y1, Y3, Y5, Y6, and Y4 as shown in the second type Type 2 of the foregoing FIG. 11, and in a second block comprising the sixth scan electrode Y6 through the tenth scan electrode Y10, scan signals can be consecutively applied to the sixth, eighth, tenth, seventh, and ninth scan electrodes Y6, YB, Y10, Y7, and Y9 as show in the second type Type 2 of the foregoing FIG. 11. Likewise, scan types can be set, respectively, for each block comprising one or more scan electrodes.

Although the number of scan electrodes belonging to each block has been set to be equal in the above, it is possible to set the number of scan electrodes belonging to at least one block different from the number of scan electrodes belonging to other blocks. For example, the first block may comprise 10 scan electrodes, while the second block may comprise 100 scan electrodes.

Further, although the above description has been made with respect to a case where the scan type applied to each block is the same, the scan type applied to at least one block may be different from the scan type applied to other blocks. For example, the third type Type 3 of FIG. 11 may be applied to the first block, and the fourth type Type 4 of FIG. 11 may be applied to the second block.

Moreover, if a different scan type is applied to each block, scan signals can be applied to the scan electrodes with respect to the scan type in which the number of times of switching of the data driver is the smallest in response to image data input for each block.

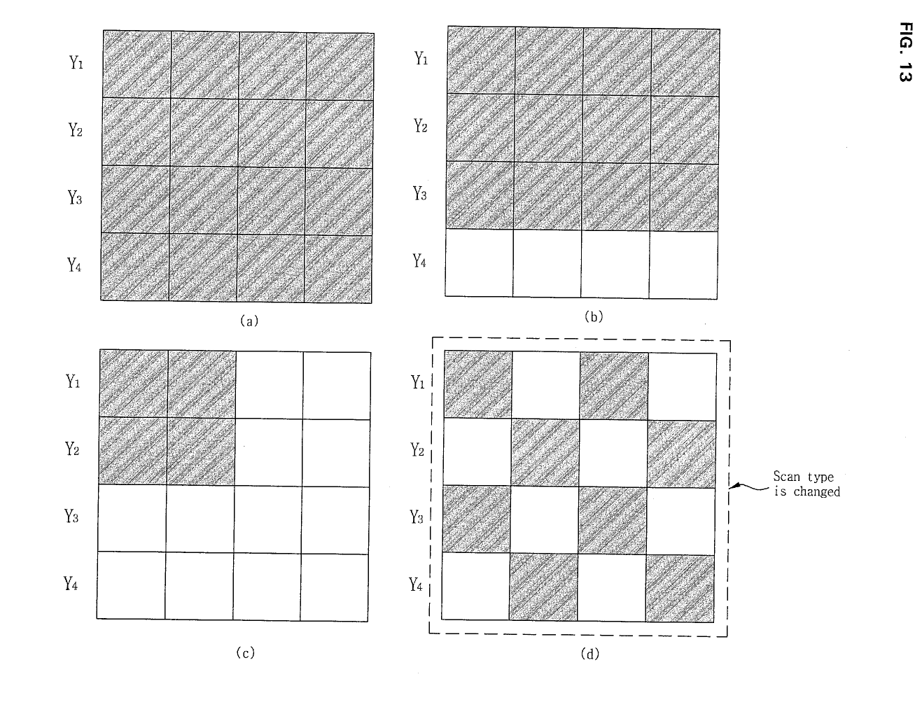

FIG. 13 is a view for explaining another example of a method for determining a scan type relative to a threshold value of the number of times of switching.

Referring to FIG. 13, if the number of times of switching of the driver generated in response to input image data is greater than a threshold voltage, the scan type may be changed.

For example, (a) shows a case where a data signal having a high voltage level is applied to the discharge cells arranged on all the scan electrodes Y1˜Y4 lines, (b) shows a case where a data signal having a high voltage level is applied to the discharge cells arranged on the first, second, and third scan electrodes Y1, Y2, and Y3 lines and a data signal having a low voltage level is applied to the discharge cell arranged on the fourth scan electrode Y4 line, (c) shows a case where a data signal having a high voltage level is applied to the first and second discharge cells arranged on the first and second scan electrode Y1 and Y2 lines, and a data signal having a low voltage level is applied to the remaining discharge cells, and (d) shows a case where a data signal having a high voltage level is applied to every other discharge cell.

In the case of (a), the total number of times of switching of the data driver is 0 because there occurs no change in voltage level of a data signal. In the case of (b), the total number of times of switching of the data driver is 4because the voltage level of a data signal is changed a total of four times. In the case of (c), the total number of times of switching of the data driver is 2. In the case of (d), the total number of switching of the data driver is 12. Assuming that a total of 10 times of switching operations is a threshold value, only the image data of the last (d) pattern among image data of the (a), (b), (c), and (d) patterns may cause the number of times of switching to be greater than or the same as the threshold value.

As above, if the number of times of switching is greater than or the same as the threshold value, this indicates that an electrical damage may be exerted on the driver.

Therefore, in case of image data of the (a), (b), and (c) patterns, scan signals are applied in the order of the first, second, third, and fourth scan electrodes Y1, Y2, Y3, and Y4, and in case of image data of the (d) pattern, as shown in the second type Type 2 of the foregoing FIG. 11, scan signals are applied in the order of the first, third, second, and fourth scan electrodes Y1, Y3, Y2, and Y4. In this way, it is possible to change the scan type only in the case of image data of a specific pattern.

As above, if the number of times of switching of the data driver with respect to the first scan type Type 1 for sequentially applying scan signals to a plurality of scan electrodes in response to input image data is below a threshold value, scan signals are applied to the scan electrodes using the first scan type Type 1. On the other hand, if the number of times of switching of the data driver with respect to the first scan type Type 1 in response to input image data is greater than a threshold value, scan signals are applied to the scan electrodes using the second can type Type 2 which is different from the first scan type Type 1.

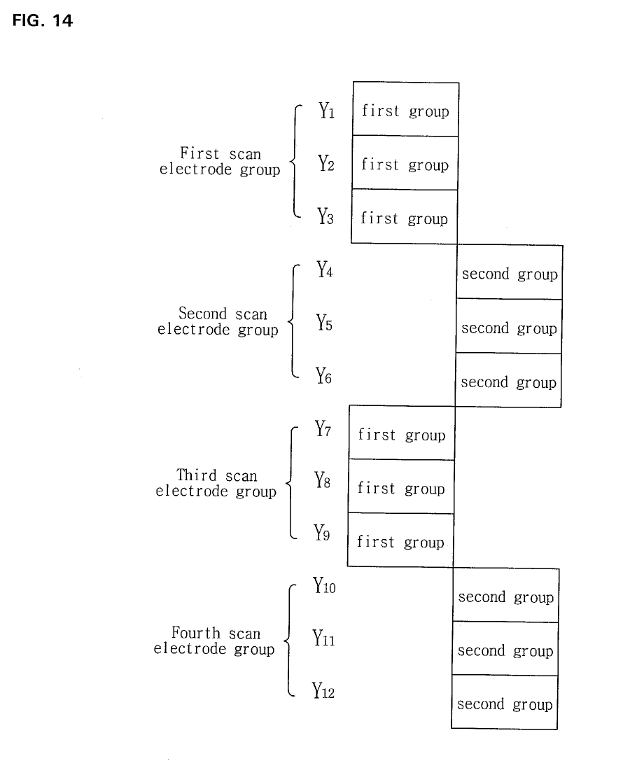

FIG. 14 is a view for explaining still another example of a method method for applying scan signals to scan electrodes using at least one scan type of a plurality of scan types which are different from each other in the order of applying scan signals to the scan electrodes.

Referring to FIG. 14, although the above description has been made with respect to a case where scan signals are applied to the scan electrodes Y using a scan type having a scan order corresponding to each scan electrode Y, it is possible to set the scan electrodes Y to a plurality of scan electrode groups and apply scan signals with respect to the setting.

For example, the first, second, and third scan electrodes Y1, Y2, and Y3 are set to the first scan electrode group, the fourth, fifth, and sixth scan electrodes Y4, Y5, and Y6 are set to the second scan electrode group, the seventh, eighth, and ninth scan electrodes Y7, Y8, and Y9 are set to the third scan electrode group, and the tenth, eleventh, and twelfth scan electrodes Y10, Y11, and Y12 are set to the fourth scan electrode group. Although in FIG. 14, each scan electrode group is set to comprise three scan electrodes, it is possible to variously change the number of scan electrodes to 2, 4, 5, etc.

Also, it is possible to set at least one of the plurality of scan electrode groups so as to comprise a different number of scan electrodes Y from the other scan electrode groups.

AS above, in the case that the scan electrode groups are set, if the second type Type 2 of the foregoing FIG. 11 is applied, scan signals are consecutively applied to the scan electrodes belonging to the first scan electrode group, i.e., the first, second, and third scan electrodes Y1, Y2, and Y3, then scan signals are consecutively applied to the scan electrodes belonging to the third scan electrode group, i.e., the seventh, eighth, and ninth scan electrodes Y7, Y8, and Y9, then scan signals are consecutively applied to the scan electrodes belonging to the second scan electrode group, i.e, the fourth, fifth, and sixth scan electrodes Y4, Y5, and Y6, and then scan signals are consecutively applied to the scan electrodes belonging to the fourth scan electrode group, i.e., the tenth, eleventh, and twelfth scan electrodes Y10, Y11, and Y12. In other words, scan signals are applied in the application order of the first, second, third, seventh, eighth, ninth, fourth, fifth, sixth, tenth, eleventh, and twelfth scan electrodes Y1, Y2, Y3, Y8, Y9, Y4, Y5, Y6, Y10, Y11, and Y12.

As above, it is possible to apply a type for consecutively applying scan signals to the scan electrodes belonging to at least one of the plurality of scan electrode group comprising at least one of the plurality of scan electrodes.

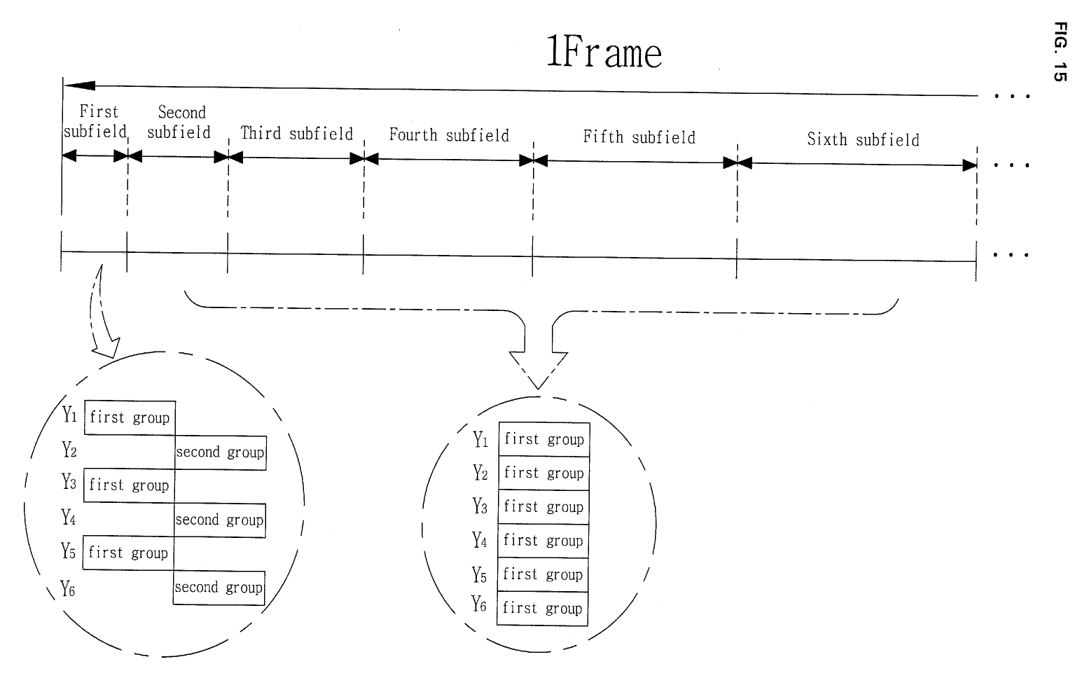

FIG. 15 is a view for explaining one example of a method for determining a scan type in consideration of a subfield.

Referring to FIG. 15, the scan type in at least one subfield of an image frame may be different from the scan type in other subfields. For example, the second type Type 2 of the foregoing FIG. 11 is used in the first subfield, and the first type Type 1 of the foregoing FIG. 11 is used in other subfields.

This can be implemented by applying scan signals to the scan electrodes with respect to the scan type in which the number of times of switching o the data driver is the smallest in response to image data input for each subfield of one image frame. For example, in FIG. 15, image data of the first subfield can be applied when the number of times of switching of the data driver generated when the second type Type 2 of the foregoing FIG. 11 is the smallest, and image data of the other subfields can be applied when the number of switching of the data driver generated when the first type Type 1 of the foregoing FIG. 11 is the smallest.

This document being thus described, it will be obvious that the same may be varied in many ways. Such variations are not to be regarded as a departure from the spirit and scope of this document, and all such modifications as would be obvious to one skilled in the art are intended to be included within the scope of the following claims.

What is claimed is:

1. A plasma display apparatus, comprising:
a plurality of scan electrodes;
a plurality of sustain electrodes formed parallel to the scan electrodes;
data electrodes intersecting the scan electrodes and the sustain electrodes;
a scan driver for applying scan signals to the plurality of scan electrodes using a first scan type in a first subfield of an image frame and applying scan signals to the plurality of scan electrodes using a second scan type, which is different from the first scan type in the order of applying scan signals, in a second subfield;
a data driver for applying data signals to the data electrodes in phase with the scan signals during an address period and applying data signals to at least one of a plurality of data electrode groups comprising at least one data electrode at a time point different from an application time point of a scan signal applied to the scan electrodes; and
a sustain driver for applying to the sustain electrodes a first sustain bias signal, whose voltage is lower than that of a second sustain bias signal applied to the sustain electrodes during an address period, during a period starting from a set-down period of a reset period, which is earlier than the address period, before a scan signal is applied to the scan electrodes.

2. The plasma display apparatus of claim 1, wherein the number of times of switching of the data driver with respect to the first scan type in the first subfield is smaller than the number of times of switching of the data driver with respect to the second type in the first subfield.

3. The plasma display apparatus of claim 2, wherein the number of times of switching of the data driver is the number of changes in voltage level of a data signal.

4. The plasma display apparatus of claim 1, wherein at least one of the first and second types is a type for consecutively applying scan signals to odd-numbered scan electrodes and even-numbered scan electrodes, respectively.

5. The plasma display apparatus of claim 1, wherein the plurality of scan electrodes comprises first, second, and third scan electrodes, to which the scan signals are applied in a consecutive order, and the interval between the first scan electrode and the second scan electrode approximately the same as the interval between the second scan electrode and the third scan electrode.

6. The plasma display apparatus of claim 1, wherein the scan driver applies scan signals to the scan electrodes using one of the first and second scan types, in which the number of times of switching of the data driver is the smallest, in response to image data input for each subfield of one image frame.

7. The plasma display apparatus of claim 1, wherein at least one of the first and second scan types is a type for consecutively applying scan signals to the scan electrodes belonging to one scan electrode group.

8. The plasma display apparatus of claim 1, wherein the scan driver applies scan signals to the scan electrodes using at least one of the first and second scan types, in which the number of times of switching of the data driver in response to input image data is below a threshold value.

9. The plasma display apparatus of claim 1, wherein if the number of times of switching of the data driver with respect to the first scan type is greater than a threshold value, the scan driver applies scan signals to the scan electrodes using the second scan type, in which the number of times of switching of the data driver in response to input image data is below a threshold value.

10. The plasma display apparatus of claim 1, wherein the first san type is a type for sequentially applying scan signals to the plurality of scan electrodes, and
the scan driver applies scan signals to the scan electrodes using the first scan type if the number of times of switching of the data driver with respect to the first scan type in response to input image data is below a threshold value, and applies scan signals to the scan electrodes using the second scan type if the number of times of switching of the data driver with respect to the first scan type in response to input image data is greater than a threshold value.

11. The plasma display apparatus of claim 1, wherein the voltage of the first sustain bias signal is approximately a ground (GND) level voltage.

12. The plasma display apparatus of claim 1, wherein a voltage of the second sustain bias signal is a voltage less than or the same as a voltage Vs of a sustain signal applied to at least either of the scan electrodes and the sustain electrodes in the sustain period subsequent to the address period.

13. The plasma display apparatus of claim 1, wherein in a predetermined subfield of the subfields of one image frame, the sustain driver applies a first sustain bias signal, which has a lower voltage than that of a second sustain bias signal applied to the sustain electrodes in the address period, during a period starting from a set-down period of the reset period, which is earlier than the address period, before a scan signal is applied to the scan electrodes.

14. The plasma display apparatus of claim 1, wherein after the first sustain bias signal is applied to the sustain electrodes, the sustain driver applies a rising signal, whose voltage gradually rises from the voltage of the first sustain bias signal to the voltage of the second sustain bias signal, to the sustain electrodes.

15. The plasma display apparatus of claim 14, wherein the slope of the rising signal is slower than a rising slope of the sustain signal applied to at least either of the scan electrodes and the sustain electrodes in the sustain period subsequent to the address period.

16. The plasma display apparatus of claim 1, wherein the data electrode groups comprises one or more data electrodes.

17. The plasma display apparatus of claim 1, wherein the data electrode groups comprises a first data electrode group and a second data electrode group, and the number of data electrodes belonging to the first data electrode group and the number of data electrodes belonging to the second data electrode group are approximately the same.

18. The plasma display apparatus of claim 1, wherein the difference between two application time points of data signals applied to two or more different data electrode groups at a different point of time is above than 10 nano seconds (ns) and below 1,000 nano seconds (ns).

19. The plasma display apparatus of claim 1, wherein the difference between two application time points of data signals applied to two or more different data electrode groups at a different point of time is below the width of a predetermined scan signal and above 1/100 of the width of the predetermined scan signal.

20. A driving method of a plasma display apparatus, the plasma display apparatus comprising a plurality of scan electrodes and sustain electrodes and data electrodes intersecting the scan electrodes and the sustain electrodes, comprising:
applying scan signals to the plurality of scan electrodes using a first scan type in a first subfield of an image frame;
applying scan signals to the plurality of scan electrodes using a second scan type, which is different from the first scan type in the order of applying scan signals;
applying data signals to the data electrodes in phase with the scan signals during an address period and applying data signals to at least one of a plurality of data electrode groups comprising at least one data electrode at a time point different from an application time point of a scan signal applied to the scan electrodes; and
applying to the sustain electrodes a first sustain bias signal, whose voltage is lower than that of a second sustain bias signal applied to the sustain electrodes during an address period, during a period starting from a set-down period of a reset period, which is earlier than the address period, before a scan signal is applied to the scan electrodes.
